(19) United States
(12) Patent Application Publication
(10) Pub. No.: US 2024/0300783 A1
(43) Pub. Date: Sep. 12, 2024

(54) MOBILE INSTALLATION DEVICE

(71) Applicant: CLIMALIFT s.r.o., Klimkovice (CZ)

(72) Inventors: Radmila Jablonska, Klimkovice (CZ); Libor Jablonski, Klimkovice (CZ)

(21) Appl. No.: 18/587,390

(22) Filed: Feb. 26, 2024

(30) Foreign Application Priority Data
Mar. 6, 2023 (CZ) PV 2023-89

(51) Int. Cl. B66C 23/20

(52) U.S. Cl. CPC B66C 23/208

(57) ABSTRACT

The invention relates to a mobile installation device for easy handling and installation of objects, in particular outdoor air conditioning units and heat pumps. Mobile installation device, characterized in that it comprises at least one hollow central part which is provided with at least one strut (2) on the front side, the strut (2) being provided with at least one stabilizing element (3, 3′) at each end and furthermore at least one hollow upper part (4) is inserted into one end of the hollow central part (1) and at least one hollow lower part (5) is inserted into the other end of the hollow central part (1), wherein at least one positioning part (6) is inserted into the hollow lower part (5) and is provided with at least one stabilization plate (7) at its rear side, and furthermore at least one positioning part (8) is inserted into the hollow upper part (4) and is provided with at least one console (9) which is perpendicular to the front side of the positioning part (8), the console (9) being provided with at least one pulley (10).

### RELATED APPLICATIONS

This application claims the priority benefit of Czech Patent Application Serial No. PV 2023-89 entitled “MOBILE INSTALLATION DEVICE,” filed Mar. 6, 2023, the entire disclosure of which is incorporated herein by reference.

### TECHNICAL FIELD

The technical solution relates to a mobile installation device for easy handling and installation of objects, especially outdoor units of air conditioners and heat pumps.

### BACKGROUND ART

From the state of the art, there are known methods for mounting outdoor units of air conditioners or heat pumps on the walls of buildings, the most common method is by means of classic ladders, where two workers carry or pull the unit with an average weight of about 70 kg to the desired height and place it on the structure for fixing the specific equipment. Another well-known method of placing the unit on the mounting structure is by means of a mobile crane or a work platform.

There is a known solution according to Czech Patent No. 2294635, entitled “Lifting device,” in particular for mounting and dismounting lute fans in a mining environment, consisting of a rail chassis, a frame, a telescopic guide, and a hydraulic cylinder and an aggregator, the essence of which is to enable the loaded fan to be transported to the site without reloading and then lifted to the installation site. The disadvantage of that invention is the necessary use of tracks as a transport route, which is completely avoided when installing the present solution on the walls of buildings. Furthermore, the use of hydraulic elements significantly increases the weight of the device, which completely precludes the use of the related solution for the above installation of outdoor air conditioning and heat pump units.

Furthermore, there is known a solution according to Czech Invention Application No. 2002-90, entitled “Lifting device,” of a two-part folding device comprising an upper plate rotatably fixed along a horizontal first axis to a top plate or a partition of a cabinet and a lower plate rotatably connected to the upper plate along a second axis parallel to the first axis. The device includes at least one two-arm lever rotatably mounted on a horizontal rotatable axle in the side of the enclosure, the longer arm of which is connected to the bottom plate. A compression spring member is rotatably attached to the body of the housing at one end and rotatably attached to the lever at the other end. Contact between the bottom plate and the surface of the housing is prevented by the lever being tilted along its rotating axle and the shorter arm of the lever is guided by means of a slide or rollers through a guiding template fixed to the body of the cabinet. Said solution provides a completely different technical solution from the present invention.

It is also known a solution, according to the Czech Invention Application No. 2004-977, entitled “Lifting device,” which is intended for lifting loads and persons and consists of mutually connected platforms, where between the lower platform and the upper platform, an air bag is placed in a single-chamber or multi-chamber design. Said solution provides a completely different technical solution from the present invention.

There are also known devices and methods using hydraulic drive and lever mechanisms, the disadvantages of which are that they require stabilization on a base plate, i.e., on the ground, and the worker always has to use a ladder to climb up to pull the outdoor air conditioning or heat pump unit up and place it on the structure for fixing. Further, there are known solutions, for example, according to Indian Invention Application No. IN202241073111 entitled “Auxiliary device for lifting objects,” solution according to Indian Invention Application No. IN202211064872 entitled “Device for lifting goods,” solution according to Indian Invention Application No. IN202211064162 entitled “Device for lifting objects,” solution according to Australian Invention Application No. AU2022100125 entitled “Lifting device,” all of which are of a completely different technical design and are directed to a different field of application.

### DISCLOSURE OF THE INVENTION

Said disadvantages are eliminated by the mobile installation device according to the present invention, the essence of which consists in comprising at least one hollow central part which is provided with at least one strut on the front side, the strut being provided with at least one stabilizing element at each end thereof. At least one hollow upper part is inserted into one end of the hollow central part and at least one hollow lower part is inserted into the other end of the hollow central part. At least one positioning lower part is inserted into the hollow lower part and is provided with at least one stabilization plate on its rear side.

At least one positioning upper part is inserted into the hollow upper part and is provided with at least one console which is perpendicular to the front side of the positioning part, the console being provided with at least one pulley.

It is advisable that the pulley be adapted as a positioning pulley along the cantilever and that the cantilever be reinforced with at least one reinforcing lintel to ensure the strength of the upper part of the structure.

Advantageously, the strut is provided with at least one positioning element at each end for adjusting the strut span, and is also provided with two stabilizing elements, preferably two at each end, it being expedient that the stabilizing elements are connected by a pressure plate. It is further advantageous that the strut is provided with at least one stop at each end to prevent the positioning element from being displaced.

It is also expedient that the stabilization plate is adjusted by means of a screw as a positioning plate in the direction towards and away from the positioning lower part.

It is advisable that the length of the upper and lower parts from the hollow center piece is the same.

### BRIEF DESCRIPTION OF THE FIGURES

Embodiments of the present invention are described herein with reference to the following drawing figures, wherein:

FIG. 1 schematically shows the mobile installation device.

FIG. 2 shows the lower half of the mobile installation device, which is fitted with a running element for use as a rudder.

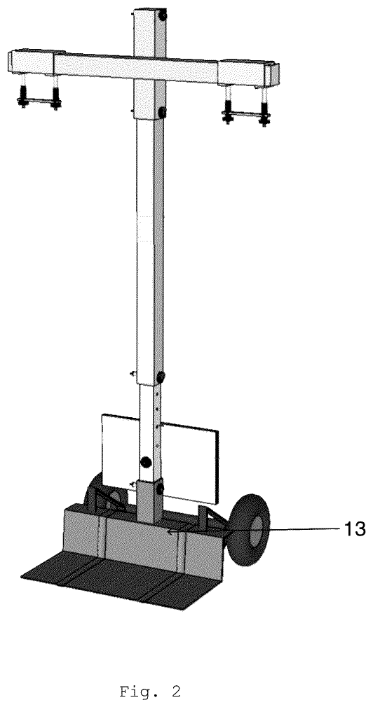

FIG. 3 shows a mobile installation device mounted on a mounting structure, with an outdoor air conditioning unit attached to a pulley.

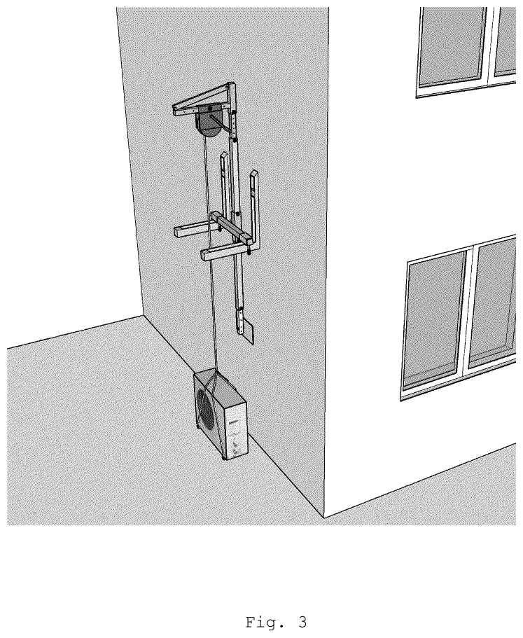

FIG. 4 shows the outdoor air conditioning unit being pulled up on the structure for attachment.

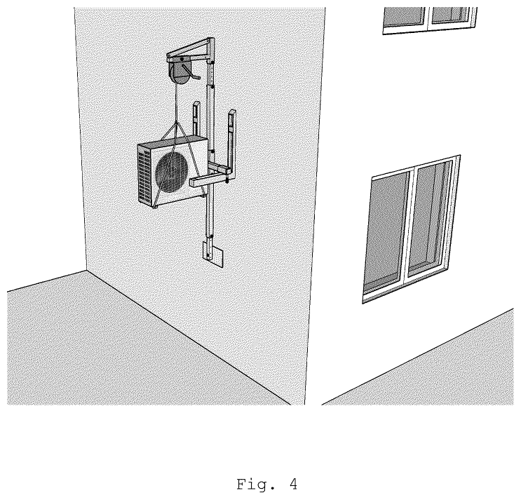

### DETAILED DESCRIPTION

This invention can be further illustrated by the following examples of embodiments thereof, although it will be understood that these examples are included merely for the purposes of illustration and are not intended to limit the scope of the invention unless otherwise specifically indicated.

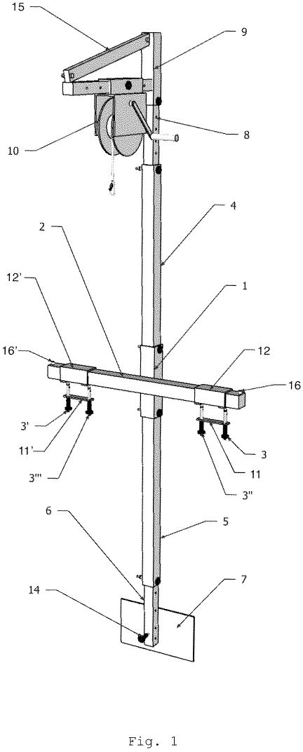

As shown in FIG. 1, the mobile installation device comprises at least one hollow central part 1 which is provided with at least one strut 2 on the front side, by way of example the strut 2 is welded to the hollow central part 1, both parts being preferably made of light metals in order to keep the weight of the device as low as possible.

The strut 2 is provided at both ends with a pressure plate 11, in which are placed stabilizing elements 3, 3′, for attaching the device to the structure for mounting, for example, an outdoor air conditioning unit. In the most preferred embodiment, the pressure plate 11 is secured by means of head screws 3, 3″ and 3′, 3′″ which pass through the pressure plate 11 and are fixed in the strut 2, the distance between the stabilizing element 3 and 3″ being the same as that between the stabilizing element 3′ and 3′″. By way of example, the stabilizing elements are represented as head screws. Further, in a preferred embodiment, the strut 2 is provided with a positioning element 12, 12′ at each end thereof, which allows the span of the strut 2 to be adjusted according to the distance of the mounting structure consoles, wherein stops 16, 16′ are provided at each end of the strut 2 to prevent the positioning elements 12, 12′ from being extended.

There is at least one hollow upper part 4 inserted into one end of the hollow central part 1, which is secured by an exemplary locking device, the hollow upper part 4 being is provided at its end with a positionable upper part 8, wherein the provision of positionability is in a preferred embodiment provided by holes for locating the locking positioning fixture. Said positioning upper part 8 is provided with a console 9, which is secured by means of a locking screw, as an example. The console 9 is perpendicular to the front side of the positioning upper part 8. The console 9 is provided with at least one pulley 10 which can be positioned on the console 9, the position of which is then secured by means of an exemplary positioning clamp.

The pulley 10 is presented as a standard pulley with a winding cable fitted with a hook, in the preferred version it is equipped with an automatic brake.

In order to provide strength to the console 9 when the example outdoor air conditioning unit is suspended from the pulley 10, the mobile installation device is provided with a reinforcing lintel 15 which is preferably dismountably connected to the console 9.

At least one hollow lower part 5 is inserted into the other end of the hollow central part 1, which is provided at one end with a positioning lower part 6, wherein the provision of positionability is preferably provided by holes for the positioning locking clamp. Said positioning lower part 6, the position of which is secured by an exemplary locking screw, is provided on its rear side with at least one stabilizing plate 7. The position of the stabilization plate 7 relative to the positioning lower part 6 is adjustable so that the stabilization plate Z is urged against the wall on which the device is mounted.

In a preferred embodiment, the adjustability is made possible by a bolt 14 which is preferably provided with a wing nut.

In an advantageous embodiment, the free end of the positioning lower part 6 can be fitted with a travel element 13 which is fixed to the positioning lower part 6, for example by means of a locking screw.

### Example 1

An example describes the installation of an outdoor air conditioning unit weighing approximately 70 kg on a mounting structure that is attached to the wall of the house at a height of example 5 m.

The mobile installation device in its standard assembly is disassembled into its basic parts, namely as a hollow central part 1 comprising a strut 2, then a hollow upper part together with a positioning upper part 8 and a console 9 with a pulley 10, and then a hollow lower part 5 comprising a positioning lower part 6 with a stabilizing plate 7 and then a separate running element 13.

As an example, the hollow central part 1 is connected by means of a locking screw to the hollow lower part 5 comprising a positioning lower part 6 with a stabilizing plate 7, where a travel element 13 is fitted to the free end of the positioning lower part 6 and secured by the locking screw. This creates a mobile transport device on which the example outdoor air conditioning unit can be placed and can thus be easily transported to the installation site. At the site, the outdoor air conditioning unit is placed, for example, on the ground under the frame and the travel element 13 is dismantled. The hollow center part 1 is fitted with a hollow top part 4 with a positioning top part 8 and a console 9 with a pulley 10, which is secured by an example locking screw. The individual parts are secured together by means of positioning clamps. The mobile lifting device, thus assembled, is deployed on the structure for mounting the outdoor air-conditioning unit. According to the spacing of the mounting consoles of the mounting structure, the span of the strut 2 is adjusted by means of the positioning elements 12, 12″ and this is then secured by means of the stabilizing elements 3, 3″ and 3′, 3′″ which fix the pressure plate 11 to the mounting consoles of the mounting structure for the outdoor air conditioning unit.

The position of the mobile installation device is fixed against tipping by means of a stabilizing plate Z which is pressed against the building wall by means of a bolt 14 with a wing nut for easy tightening.

In the most preferred embodiment, the length of the upper and lower parts from the hollow center part 1 is the same.

An outdoor air conditioning unit is suspended by straps from the hook of the pulley 10 of the mobile installation device thus fixed and is hoisted onto the structure for attachment.

After installation, when the outdoor air conditioning unit is firmly attached to the mounting structure, the mobile installation device is dismantled according to the reverse sequence of its installation.

The mobile installation device can be used for any installation of outdoor air conditioning or heat pump units without any additional interventions in the building wall and then also for transporting the installed units from the transport vehicle to the installation site.

### INDUSTRIAL APPLICABILITY

The mobile installation device according to the present invention can be used for the installation of outdoor air conditioning and heat pump units, while ensuring safe and physically easy installation by only one worker, without any additional intervention in the wall of the building on which the unit is installed.

### LIST OF MARKINGS

1 hollow center part
2 strut
3 stabilizing element
4 hollow upper part
5 hollow lower part
6 positioning lower part
7 stabilization plate
8 positioning upper part
9 console
10 pulley
11 pressure plate
12 positioning element
13 running element
14 bolt with wing nut
15 reinforcing lintel
16 stop

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

### Claims not Limited to Disclosed Embodiments

The preferred forms of the invention described above are to be used as illustration only, and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

What is claimed is:

1. A mobile installation device, characterized in that it comprises at least one hollow central part (1) which is provided with at least one strut (2) on a front side, the strut (2) being provided with at least one stabilizing element (3, 3′) at each end, and furthermore at least one hollow upper part (4) is inserted into one end of the hollow central part (1) and at least one hollow lower part (5) is inserted into the other end of the hollow central part (1), wherein at least one positioning part (6) is inserted into the hollow lower part (5), which is provided with at least one stabilization plate (7) on its rear side, and furthermore at least one positioning part (8) is inserted into the hollow upper part (4), which is provided with at least one console (9) which is perpendicular to the front side of the positioning part (8), the console (9) being provided with at least one pulley (10).

2. The mobile installation device according to claim 1, characterized in that the pulley is adapted to be positioned on the console (9).

3. The mobile installation device according to claim 1, characterized in that the strut is provided at each end with at least one pressure plate (11, 11′) in which the stabilizing elements (3, 3′, 3″, 3′″) are arranged.

4. The mobile installation device according to claim 1, characterized in that the distance between the stabilizing element (3) and (3″) is the same as (3′) and (3′″).

5. The mobile installation device according to claim 1, characterized in that the strut (2) is provided with two positioning elements (12, 12′) at each end for adjusting the size of the strut (2).

6. The mobile installation device according to claim 1, characterized in that the strut (2) is provided with at least one stop (16, 16′) at each end to prevent the extension of the positioning element (12, 12′).

7. The mobile installation device according to claim 1, characterized in that the lower positioning part (6) is provided with at least one travel element (13).

8. The mobile installation device according to claim 1, characterized in that the stabilizing plate (7) is adapted to be positioned in a direction towards and away from the positioning part (6) by means of a screw (14).

9. The mobile installation device according to claim 1, characterized in that the console (9) is provided with at least one reinforcing lintel (15).

10. The mobile installation device according to claim 1, characterized in that the length of the upper and lower parts from the hollow central part (1) is the same.
